(19) United States
(12) Patent Application Publication
(10) Pub. No.: US 2012/0178505 A1
(43) Pub. Date: Jul. 12, 2012

(54) SMART CHARGING SYSTEM

(75) Inventors: Chao-Tung Yang, Hsinchu (TW); Eric B. Shin, Hsinchu (TW)

(73) Assignee: LINGO LIMITED, Kowloon (HK)

(21) Appl. No.: 13/048,853

(22) Filed: Mar. 15, 2011

(30) Foreign Application Priority Data
Jan. 10, 2011 (TW) 100200519

(51) Int. Cl. H04M 1/00

(52) U.S. Cl. 455/573

(57) ABSTRACT

A smart charging system is provided, which includes a handheld device and an insertion device. An interactive application program is built in the handheld device. The insertion device has a protective case for protecting the handheld device, a connector, a slave battery module and a slave application circuit. When the handheld device is placed into the insertion device, the connector is coupled to the handheld device to activate the interactive application program to proceed a two-way communication. The handheld device has a control power of the slave application circuit. The handheld device displays an interactive graphical user interface to guide a user to set the insertion device, so as to provide electricity for the handheld device. The system can upgrade a battery endurance of the handheld device and solve problems of unable to replace the battery and charge saturation of the battery.

### CROSS-REFERENCE TO RELATED APPLICATION

This application claims the priority benefit of Taiwan application serial no. 100200519, filed Jan. 10, 2011. The entirety of the above-mentioned patent application is hereby incorporated by reference herein and made a part of this specification.

### BACKGROUND

1. Field of the Disclosure

The disclosure relates to a mobile power supply. Particularly, the disclosure relates to a smart charging system for upgrading battery endurance of a handheld device.

2. Description of Related Art

General handheld devices, for example, smart phones, personal digital assistants (PDAs), portable digital multimedia players, and tablet computers all have developing trends of lightness, slimness and portability. Since the handheld device is light and slim, a protective case is used to protect the handheld device from scratching or breaking. A material of the protective case of the handheld device includes rubber, metal or plastic, and the protective case is only used for protecting the external surface of the handheld device.

Moreover, in the mobile phones sold in the market, for example, iPhone of the APPLE Company, a battery therein cannot be replaced, and the battery is fixed inside the iPhone by welding. Therefore, when a user uses the iPhone outdoors, if the battery power is used out, a problem that the battery cannot be replaced is occurred.

Referring to FIG. 1, FIG. 1 is a diagram illustrating a protective case embedded with a charger according to an existing technique. The protective case 110 is used for protecting a mobile phone 120 and resolving the above problem that the battery therein cannot be replaced. In FIG. 1, when the mobile phone 120 is placed into the protective case 110 and is connected to a connector 115, a mobile power supply charges the mobile phone 120. Referring to FIG. 2, FIG. 2 is a diagram illustrating another protective case 210 embedded with a charger according to the existing technique. A backside of the protective case 210 has a light emitting diode (LED) lamp 215 for displaying a charging status of the backup power. However, both of the charging methods of FIG. 1 and FIG. 2 may keep the mobile phone in a charging state, and if the protective case is removed as the battery is fully charged, the mobile phone is not suitably protected.

Similar to FIG. 1 and FIG. 2, referring to FIG. 3, a protective case 310 embedded with the charger further includes a switch 315, and the user turns on the switch 315 on the protective case 310 only when the battery is required to be charged, and turns off the switch 315 after the battery is fully charged. It seems like that the protective case 310 embedded with the charger having the switch has both of the charging and protecting functions for the mobile phone, however, the following cases may cause inconveniences to the user: the user forgets to check a battery level of the mobile phone, and does not turn on the switch, and the battery of the mobile phone is used out; or the user forgets to turn off the switch, and the battery is kept charging after being fully charged, which probably shortens a service life of the battery.

Moreover, the mobile phone cannot control operations of a circuit inside the protective case.

### SUMMARY OF THE DISCLOSURE

The disclosure is directed to a smart charging system, which can resolve the problems mentioned in the related art.

An exemplary embodiment of the disclosure provides a smart charging system including a handheld device and an insertion device. An interactive application program is built in the handheld device. The insertion device has a protective case, a connector, a slave battery module and a slave application circuit. The protective case is used for protecting the handheld device. The slave battery module is coupled to the connector. The slave application circuit is coupled to the slave battery module and the connector. The slave battery module and the slave application circuit are disposed in the protective case. When the handheld device is placed into the insertion device, the connector is coupled to the handheld device to activate the interactive application program to proceed a two-way communication. The handheld device has a control power of the slave application circuit. The handheld device displays an interactive graphical user interface to guide a user to set the insertion device to provide electricity for the handheld device.

In an exemplary embodiment of the disclosure, when the user sets to charge the handheld device through the interactive graphical user interface, the handheld device controls the slave battery module to charge a battery of the handheld device through the slave application circuit.

In an exemplary embodiment of the disclosure, during a process that the slave battery module charges the handheld device, when the handheld device detects that a battery level thereof reaches a first threshold, the slave battery module stops charging the battery of the handheld device.

In an exemplary embodiment of the disclosure, the user sets to charge the handheld device through the interactive graphical user interface when a battery level of the handheld device is lower than a second threshold, when the battery level of the handheld device is lower than the second threshold, the handheld device controls the slave battery module to charge a battery of the handheld device through the slave application circuit.

In an exemplary embodiment of the disclosure, the handheld device detects a battery level of the slave battery module through the slave application circuit.

In an exemplary embodiment of the disclosure, the interactive graphical user interface displays the battery level of the slave battery module.

In an exemplary embodiment of the disclosure, the insertion device further includes a charging receptacle. The charging receptacle is coupled to the slave application circuit for inputting an external power. When the handheld device is not placed into the insertion device and the external power is coupled to the charging receptacle, the external power charges the slave battery module under control of the slave application circuit.

In an exemplary embodiment of the disclosure, the charging receptacle is a universal serial bus (USB) receptacle.

In an exemplary embodiment of the disclosure, the external power is an alternating current (AC) power.

In an exemplary embodiment of the disclosure, the external power is a direct current (DC) power of 5 volts, and the slave application circuit controls the DC power of 5 volts to charge the slave battery module.

In an exemplary embodiment of the disclosure, when the external power is coupled to the charging receptacle, the slave application circuit detects the battery level of the slave battery module, and when the battery level of the slave battery module reaches a third threshold, the slave application circuit stops the external power from charging the slave battery module.

In an exemplary embodiment of the disclosure, the insertion device further includes a charging receptacle. The charging receptacle is coupled to the slave application circuit for inputting an external power. When the handheld device is placed into the insertion device and the external power is coupled to the charging receptacle, and the user sets to charge the handheld device through the interactive graphical user interface, the handheld device controls the external power to charge the battery of the handheld device and the slave battery module through the slave application circuit.

In an exemplary embodiment of the disclosure, the handheld device is one of a smart phone, a personal digital assistant, a portable digital multimedia player and a tablet computer.

In order to make the aforementioned and other features and advantages of the disclosure comprehensible, several exemplary embodiments accompanied with figures are described in detail below.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a diagram illustrating a protective case embedded with a charger according to an existing technique.

FIG. 2 is a diagram illustrating another protective case embedded with a charger according to an existing technique.

FIG. 3 is a diagram illustrating another protective case embedded with a charger according to existing techniques.

FIG. 4 is a schematic diagram of a smart charging system according to an exemplary embodiment of the disclosure.

FIG. 5 is a schematic diagram illustrating a setting of an interactive graphical user interface 510 displayed by a screen of a handheld device.

FIG. 6 is a charging schematic diagram of an interactive graphical user interface 610 displayed by a screen of a handheld device.

FIG. 7 is a circuit block diagram of a handheld device according to an exemplary embodiment of the disclosure.

FIG. 8 is another circuit block diagram of a handheld device according to an exemplary embodiment of the disclosure.

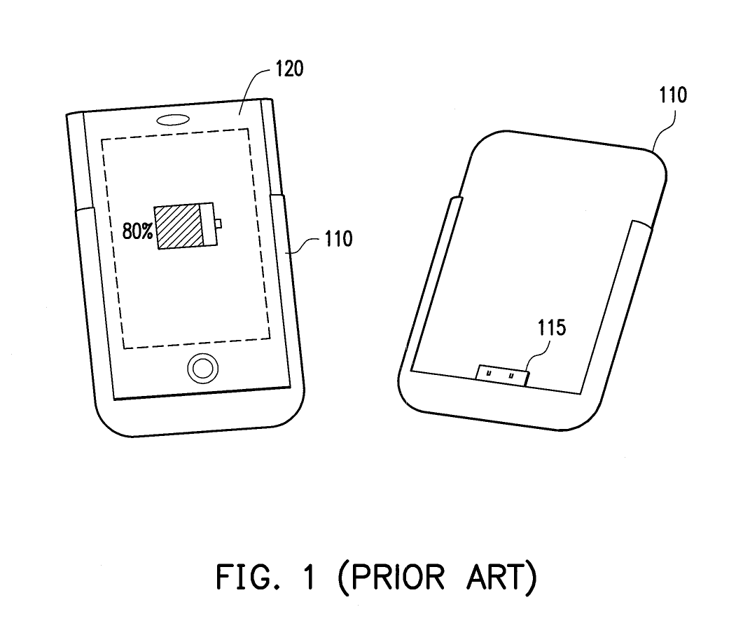

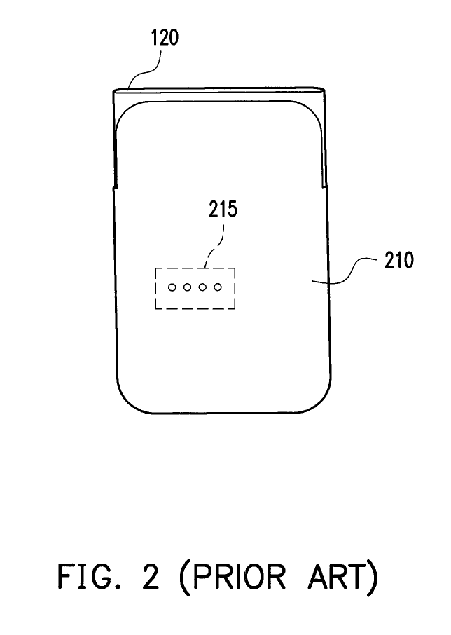

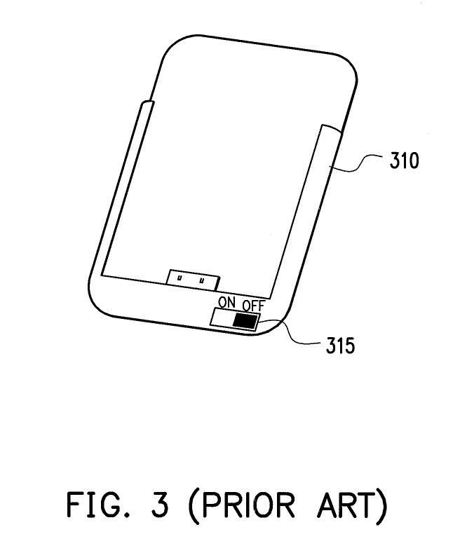

### DETAILED DESCRIPTION OF DISCLOSED EMBODIMENTS

A smart charging system of the disclosure can protect a handheld device and upgrade battery endurance of the handheld device.

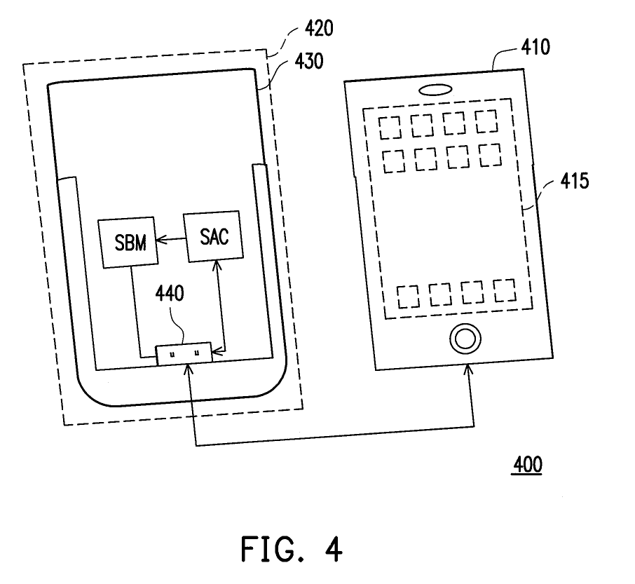

FIG. 4 is a schematic diagram of a smart charging system according to an exemplary embodiment of the disclosure. The smart charging system 400 includes a handheld device 410 and an insertion device 420. The handheld device 410 is, for example, a smart phone, a personal digital assistant, a portable digital multimedia player or a tablet computer. An interactive application program 415 is built in the handheld device 410. The insertion device 420 has a protective case 430 used for protecting the handheld device 410. A shape of the insertion device 420 is complied with a shape of the handheld device 410. A material of the protective case 430 is, for example, rubber, metal or plastic. The insertion device 420 further includes a connector 440, a slave battery module SBM and a slave application circuit SAC without a screen or buttons, where the slave battery module SBM and the slave application circuit SAC are disposed inside the protective case 430, when a user places the handheld device 410 into the insertion device 420, the connector 440 is coupled to the handheld device 410 to activate the interactive application program 415 to proceed a two-way communication. The handheld device 410 has a control power of the slave application circuit SAC, and the handheld device 410 displays an interactive graphical user interface to guide the user to set the insertion device 420 to provide electricity for the handheld device 410, so as to prolong a utilization time of the handheld device 410.

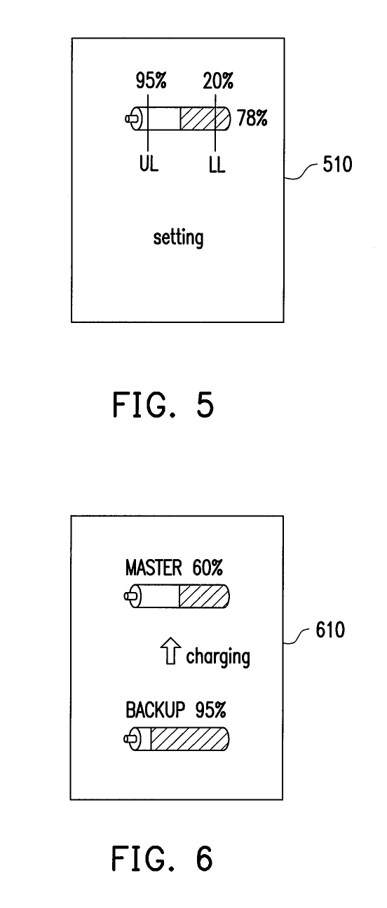

FIG. 5 is a schematic diagram illustrating a setting of an interactive graphical user interface 510 displayed by a screen of the handheld device. Referring to FIG. 4 and FIG. 5, through the interactive graphical user interface 510, the user can set to charge the handheld device 410 when a battery level of the handheld device 410 is lower than a threshold LL, and during a charging process, when the handheld device 410 detects that the battery level reaches a threshold UL, charging of the battery of the handheld device 410 is stopped, where the threshold LL<the threshold UL.

For example, in FIG. 5, the battery level of the handheld device 410 is 78% of a rated capacity, and now the thresholds LL and UL are respectively set to 20% and 95% of the rated capacity of the handheld device 410. When the handheld device 410 detects that the battery level is lower than 20% of the rated capacity, the handheld device 410 controls the slave battery module SBM to charge the battery of the handheld device 410 through the slave application circuit SAC. During the charging process, when the handheld device 410 detects that the battery level reaches 95 of the rated capacity, charging of the battery of the handheld device 410 is automatically stopped, so as to avoid charge saturation of the battery to prolong its service life.

It should be noticed that magnitudes of the thresholds LL and UL can be changed through the interactive graphical user interface 510 according to an actual requirement of the user, for example, the threshold LL can be set to 10%, and the threshold UL can be set to 99%.

In another embodiment, the threshold UL can be preset to 100%, which is not displayed on the screen of the handheld device 410, and the user can only modify the threshold LL according to an actual requirement, which can achieve the effect similar to that of the above embodiment.

FIG. 6 is a charging schematic diagram of an interactive graphical user interface displayed by a screen of the handheld device. Referring to FIG. 4 and FIG. 6, when the user sets to charge the handheld device 410 through the interactive graphical user interface 610, the handheld device 410 controls the slave battery module SBM to charge the battery of the SBM through the slave application circuit SAC. Moreover, the handheld device 410 can also detect a battery level of the slave battery module SBM through the slave application circuit SAC.

“MASTER” and “BACKUP” indicated in FIG. 6 respectively represent the battery of the handheld device 410 and the slave battery module SBM, which allow the user to know actual battery levels and level variations of the battery of the handheld device 410 and the slave battery module SBM. As shown in FIG. 6, the battery level of “MASTER” has been charged to 60% of its rated capacity, and the battery level of

“BACKUP” is dropped to 95% of its rated capacity for charging “MASTER”. Those skilled in the art should understand that the percentages shown in FIG. 6 are only used for representing variations of a charging process, and an actual charging status is not limited thereto.

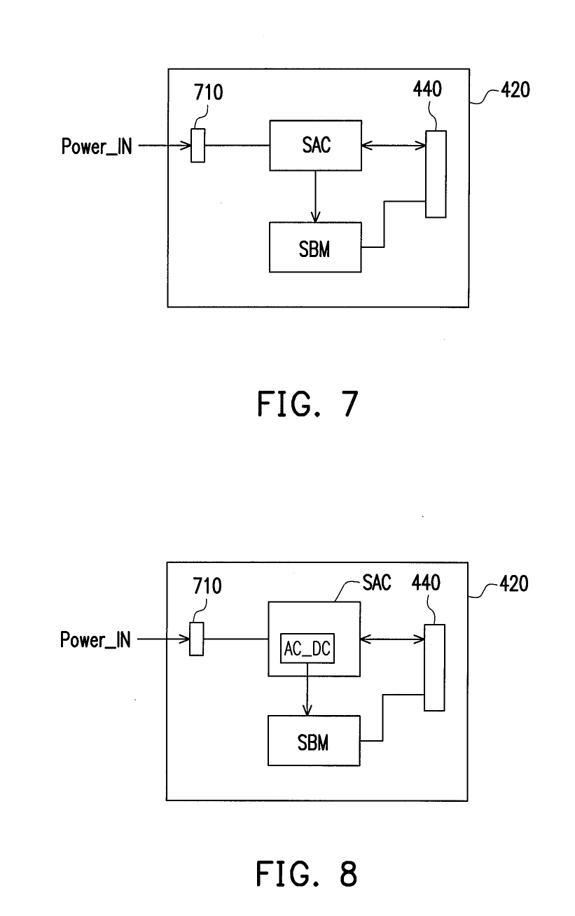

FIG. 7 is a circuit block diagram of a handheld device according to an exemplary embodiment of the disclosure. Referring to FIG. 4 and FIG. 7, the insertion device 420 may further include a charging receptacle 710. The charging receptacle 710 is coupled to the slave application circuit SAC for inputting an external power Power-IN, where when the handheld device 410 is not placed into the insertion device 420 and the external power Power_IN is coupled to the charging receptacle 710, the external power Power_IN charges the slave battery module SBM under control of the slave application circuit SAC.

It should be noticed that the charging receptacle 710 of FIG. 7 can be a universal serial bus (USB) receptacle, the external power Power_IN is a direct current (DC) power of 5 volts, and the slave application circuit SAC can control the DC power of 5 volts to charge the slave battery module SBM.

FIG. 8 is another circuit block diagram of a handheld device according to an exemplary embodiment of the disclosure. The slave application circuit SAC further includes an alternating current (AC)-DC converter AC_DC. Therefore, if the external power Power_IN is an AC power, the slave application circuit SAC can convert the external power Power_IN into the DC power, and charges the slave battery module SBM through the converted DC power.

Moreover, in case that the handheld device 410 is not placed into the insertion device 420, the salve application circuit SAC can detect the battery level of the slave battery module SBM and control a charging status of the slave battery module SBM. When the battery level of the slave battery module SBM reaches an upper threshold, charging of the slave battery module SBM is stopped. The upper threshold can be preset when the insertion device 420 is manufactured, or can be set by the user through the interactive graphical user interface when the handheld device 410 is connected to the insertion device 420.

Accordingly, the upper threshold can also be 99% of the rated capacity of the slave battery module SBM to avoid charge saturation of the slave battery module SBM. Therefore, in case that the handheld device is not placed in the insertion device 420, when the external power Power_IN is input to the charging receptacle 710, the slave application circuit SAC can charge the slave battery module SBM with the external power Power_IN, and can also detect whether the battery level of the slave battery module SBM reaches its 99% rated capacity. When the battery level of the slave battery module SBM reaches the upper threshold, the slave application circuit SAC stops charging the slave battery module SBM with the external power Power_IN.

Moreover, when the handheld device 410 of FIG. 4 is placed into the insertion device 420 of FIG. 7 or FIG. 8, and the user sets to charge the handheld device 410 through the interactive graphical user interface, the handheld device 410 can control the slave application circuit SAC to charge the battery of the handheld device 410 with the external power Power IN, or charge the slave battery module SBM, or simultaneously charge the battery of the handheld device 410 and the slave battery module SBM.

It should be mentioned that although possible patterns of the smart charging system have been described in the above embodiments, it should be understood by those skilled in the art that the design of the insertion device 420 varies with manufacturers, thus, application of the present invention should not be limited to the above possible patterns. In other words, the spirit of the present invention is met as long as the handheld device 410 controls the charging function and setting of the protective case.

In summary, in the smart charging system of the disclosure, since the handheld device can control the charging function and setting of the protective case, besides protecting the external surface of the handheld device, the insertion device can also upgrade the battery endurance of the handheld device. Moreover, the smart charging system of the disclosure can resolve the problem of the conventional art that the protective case does not have the charging function, and can also resolve a problem of charge saturation of the battery. In addition, the insertion device itself does not have a screen and buttons, so that the fabrication cost thereof is reduced, and since a design size of the insertion device is closed to a size of the handheld device, when the handheld device is combined with the insertion device, they are suitably matched, which may increase convenience in utilization.

It will be apparent to those skilled in the art that various modifications and variations can be made to the structure of the disclosure without departing from the scope or spirit of the disclosure. In view of the foregoing, it is intended that the disclosure cover modifications and variations of this disclosure provided they fall within the scope of the following claims and their equivalents.

What is claimed is:

1. A smart charging system, comprising:
a handheld device, inbuilt with an interactive application program; and
an insertion device, comprising:
a protective case, for protecting the handheld device;
a connector;
a slave battery module, coupled to the connector; and
a slave application circuit, coupled to the slave battery module and the connector,
wherein the slave battery module and the slave application circuit are disposed in the protective case, when the handheld device is placed into the insertion device, the connector is coupled to the handheld device to activate the interactive application program to proceed a two-way communication, and the handheld device has a control power of the slave application circuit, the handheld device displays an interactive graphical user interface to guide a user to set the insertion device to provide electricity for the handheld device.

2. The smart charging system as claimed in claim 1, wherein when the user sets to charge the handheld device through the interactive graphical user interface, the handheld device controls the slave battery module to charge a battery of the handheld device through the slave application circuit.

3. The smart charging system as claimed in claim 2, wherein during a process that the slave battery module charges the handheld device, when the handheld device detects that a battery level thereof reaches a first threshold, the slave battery module stops charging the battery of the handheld device.

4. The smart charging system as claimed in claim 1, wherein the user sets to charge the handheld device through the interactive graphical user interface when a battery level of the handheld device is lower than a second threshold, when the battery level of the handheld device is lower than the second threshold, the handheld device controls the slave battery module to charge a battery of the handheld device through the slave application circuit.

5. The smart charging system as claimed in claim 1, wherein the handheld device detects a battery level of the slave battery module through the slave application circuit.

6. The smart charging system as claimed in claim 5, wherein the interactive graphical user interface displays the battery level of the slave battery module.

7. The smart charging system as claimed in claim 1, wherein the insertion device further comprises:
a charging receptacle, coupled to the slave application circuit, for inputting an external power,
wherein when the handheld device is not placed into the insertion device and the external power is coupled to the charging receptacle, the external power charges the slave battery module under control of the slave application circuit.

8. The smart charging system as claimed in claim 7, wherein the charging receptacle is a universal serial bus (USB) receptacle.

9. The smart charging system as claimed in claim 7, wherein the external power is an alternating current (AC) power.

10. The smart charging system as claimed in claim 7, wherein the external power is a direct current (DC) power of 5 volts, and the slave application circuit controls the DC power of 5 volts to charge the slave battery module.

11. The smart charging system as claimed in claim 7, wherein when the external power is coupled to the charging receptacle, the slave application circuit detects the battery level of the slave battery module, and when the battery level of the slave battery module reaches a third threshold, the slave application circuit stops the external power from charging the slave battery module.

12. The smart charging system as claimed in claim 1, wherein the insertion device further comprises:
a charging receptacle, coupled to the slave application circuit for inputting an external power,
wherein when the handheld device is placed into the insertion device and the external power is coupled to the charging receptacle, and the user sets to charge the handheld device through the interactive graphical user interface, the handheld device controls the external power to charge the battery of the handheld device and the slave battery module through the slave application circuit.

13. The smart charging system as claimed in claim 1, wherein the handheld device is one of a smart phone, a personal digital assistant, a portable digital multimedia player and a tablet computer.
